(19) United States
(12) Patent Application Publication
(10) Pub. No.: US 2003/0228020 A1
(43) Pub. Date: Dec. 11, 2003

(54) Electronic control circuit and acoustic-signal emitting device for vehicles

(75) Inventors: Boris Lentinturier, Evreux (FR); Michele Schieppati, Milano (IT)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(73) Assignee: Fabbrica Italiana Accumulatori Motocarri Montecchi F.I.A.M.M. S.p.A., Vicenza (IT)

(21) Appl. No.: 10/289,050

(22) Filed: Nov. 6, 2002

(30) Foreign Application Priority Data
Jun. 7, 2002 (WO) PCT/IT02/00374

(51) Int. Cl. H04B 3/00

(52) U.S. Cl. 381/77

(57) ABSTRACT

An electronic control circuit (50) of a loudspeaker (LDSK) for vehicles, for emitting at least a first acoustic signal characteristic of an alarm siren is characterized in that it comprises storage means (Flash) for storing a plurality of digital samples representative of at least a portion of a reference acoustic signal which can be generated by a sample acoustic warning device, processing means (μP) for generating, on the basis of the plurality of samples, a modulated electrical signal (S1, S2) carrying at least a portion of the harmonic content associated with the reference acoustic signal, (S1, S2) and supplying to the loudspeaker (LDSK) a corresponding driving signal for the emission of a second acoustic signal substantially reproducing the at least one portion of the reference acoustic signal.

### FIELD OF THE INVENTION

The present invention relates to devices used for emitting acoustic signals in vehicles and to the corresponding electronic control circuitry.

### BACKGROUND OF THE INVENTION

As is known, vehicles currently in use have acoustic warning devices or horns operable by the user and typically including a fixed-coil motor, a metal diaphragm, and a suitable outlet for the acoustic radiation produced by the vibrations of the diaphragm.

Vehicles provided with alarm sirens typically for emitting a sound indicating attempted theft in relation to the vehicle are also known. In particular, some of these devices are formed by loudspeakers including moving-coil acousto-electric transducers.

Conventional alarm sirens also have suitable electronic loudspeaker-control circuits for generating an electrical signal for driving the loud speaker. For example, alarm sirens are known in which the driving signal is a square wave produced by the division of a reference frequency produced by a quartz crystal which clocks the electronic control circuit.

In vehicles currently in use, such as, for example, motorcars, the acoustic warning device is a device separate from and independent of the alarm siren.

It is pointed out that the combination of the alarm siren and acoustic warning functions in a single device seems an attractive solution for vehicle manufacturers and for the final user because it would enable the costs and the overall space occupied to be limited to those of a single device.

In this connection, it should be noted that such combination is not easy to achieve in practice because the sound emitted by the acoustic warning device, and hence its harmonic content, is notably different from that emitted by an alarm siren. This difference is not the manufacturers' choice but is the consequence of international or national regulations which set the characteristics of the sounds emitted by the two devices. This difference between the typical sounds of the two devices is also clear if it is borne in mind that the sound waves generated by an acoustic warning device normally have frequencies of the order of hundreds of hertz, whereas those generated by an alarm siren have higher frequencies, for example, of 2000 Hz.

Moreover, the acoustic signals characteristic of the two devices have specific acoustic qualities which are well known to skilled or less skilled users, who can therefore easily recognize, and will not appreciate, an unsatisfactory attempt to reproduce these sounds.

Advantageously, moreover, the combination of the two functions should not render the electronic control circuit of a particular loudspeaker used too complex.

### SUMMARY OF THE INVENTION

The object of the present invention is to propose an electronic control circuit for a loudspeaker which enables the loudspeaker to be driven in a manner such that it can operate, with satisfactory performance, both as an alarm siren and as an acoustic warning device.

The object of the present invention is achieved by a loudspeaker control circuit, a driver circuit, and a loudspeaker.

A further subject of the present invention is an acoustic-signal emitting device for vehicles capable of operating as an alarm siren, an acoustic warning device, and a vehicle status indicating device.

### BRIEF DESCRIPTION OF THE DRAWINGS

Further characteristics and the advantages of the present invention will become clear from the following description of a preferred embodiment thereof, given by way of non-limiting example, with reference to the appended drawings, in which:

FIG. 1 shows schematically a particular embodiment of a device for emitting acoustic signals according to the present invention,

FIG. 2 shows schematically a particular embodiment according to the invention of a driver circuit usable in the device, and

FIG. 3 shows a particular embodiment of a loudspeaker usable in the device.

### DETAILED DESCRIPTION OF THE INVENTION

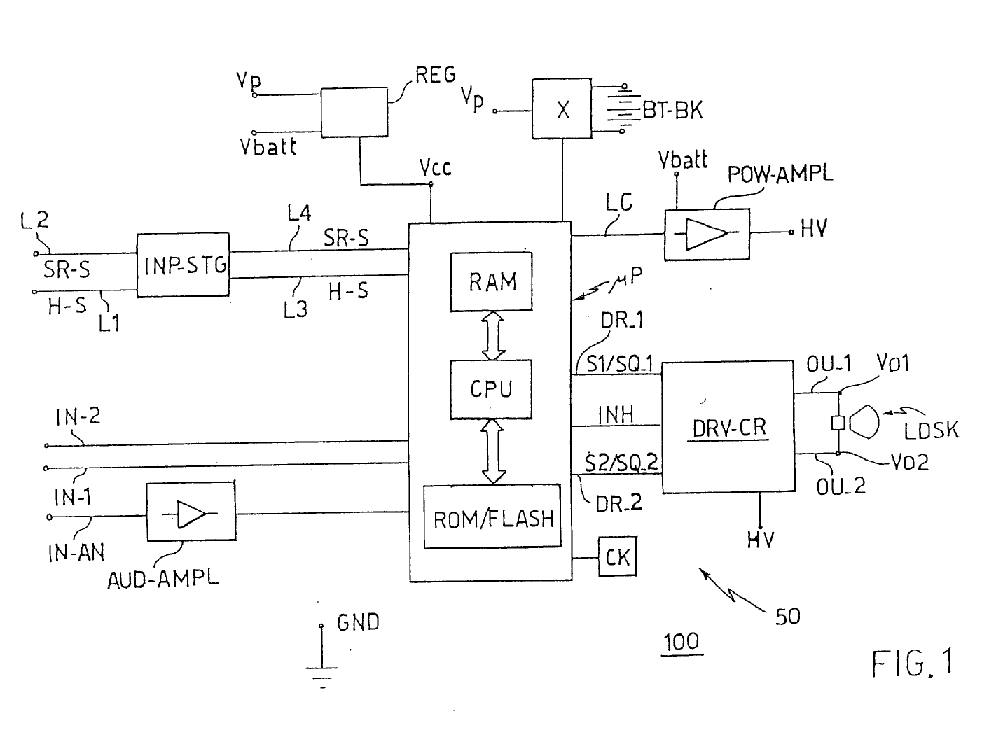

FIG. 1 shows schematically a preferred embodiment of a device 100 for emitting acoustic signals according to the invention. The device 100 is intended for use in vehicles such as, for example, motor cars and is arranged to emit acoustic signals characteristic of an alarm siren in one operative condition and to emit acoustic signals characteristic of an acoustic warning device in another operative condition.

The expression “sounds characteristic of an alarm siren” is intended to define, particularly but in non-limiting manner, the sounds emitted by alarm sirens connected to antitheft systems of the vehicle.

The emitting device 100 comprises an electronic control circuit 50 and a loudspeaker LDSK connected to the control circuit.

The control circuit 50 includes an input stage INP-STG for receiving electric control signals, processing means μP such as a programmable microcontroller, input lines IN-1 and IN-2 for signals for programming the microcontroller μP, and a driver circuit DRV-CR connectible to the loudspeaker LDSK which has its own electrical terminals V01 and V02.

The input stage INP-STG has a first line L1 for receiving a electrical horn-activation signal H-S and a second line L2 for receiving an electrical siren-activation signal SR-S. Alternatively, a single line may be provided for receiving activation signals of both types. The horn-activation signals H-S and the siren-activation signals SR-S activate/deactivate the emission, by the loudspeaker LDSK, of sound waves having frequencies typical of an acoustic warning device and of an alarm siren of a vehicle, respectively.

In particular, the horn-activation signal H-S is a signal which can be generated by the driver of the vehicle by pressing the horn button (not shown), which acts as a switch.

The siren-activation signal SR-S is, for example, a digital signal which can be generated by an electronic management unit (not shown) fitted in the vehicle, such as that of an antitheft system. Preferably the siren-activation signal SR-S is suitably encoded or encrypted so as to satisfy security criteria necessary for preventing tampering.

Advantageously, the second input line L2 is a bus for connection to the device 100, enabling signals also having other functions as well as the activation/deactivation function described above to be sent to thereto. For example, the bus L2 is also suitable for receiving signals for managing the diagnostics of the device 100 or signals for controlling the emission of acoustic signals indicating vehicle state (buzzer-type signals) and coming from a central electronic control unit of the vehicle. These state-indicating signals have the function, for example, of indicating the engagement of reverse gear, the presence of an open door, or the undesired presence of vehicle lights that are switched on.

The input stage INP-STG is arranged to make available on respective output lines L3 and L4 the activation signals H-S and SR-S, or other signals present on the input lines L1 or L2, suitably adapted (for example, filtered and protected from overvoltages) for management by the microcontroller μP.

Moreover, the control circuit 50 preferably includes a stabilized energy supply REG such as to provide, on the basis of a first voltage Vbatt generated by a battery of the vehicle (typically 12V), a second voltage Vcc which can be used to supply some components of the electronic control circuit 50 and which has a suitably reduced value relative to that of the first, battery voltage Vbatt, for example, a value of 5V.

The microcontroller μP may be of conventional type and may comprise a CPU (central processing unit), storage means such as, for example, a ROM memory or, preferably, a flash memory, a RAM memory (random access memory), and a section for interfacing with respective connection buses.

For example, the microcontroller μP, which is timed by a clock CK, may be a device of the PIC Microchip family, or an STMicroelectronics ST5/6/7 device.

The microcontroller μP is intended to receive the horn-activation signal H-S and/or the siren-activation signal SR-S from the input stage INP-STG via the output lines L3 and L4, and to generate at least one driving signal to be sent to the driver circuit DRV-CR via at least a first driving line DR-1.

The storage means of the microcontroller μP (for example, the flash memory) store a plurality of digital samples representative of at least a portion of a reference acoustic signal which can be generated by a sample acoustic warning device, for example, a conventional horn.

Advantageously, these digital samples are generated outside the device 100 and are subsequently stored in the storage means of the microcontroller μP. By generating these digital samples outside the device 100, it is possible to use analog and/or digital instrumentation suitable for achieving the desired performance without complicating the structure of the device and, in particular, that of the control circuit 50.

According to one embodiment of the invention, the digital samples are produced as a result of an analog/digital conversion (including a quantization and encoding sampling stage) of a suitable electrical signal representative of the reference acoustic signal.

In greater detail, this electrical signal is generated by an acoustic/electrical conversion (for example, by means of a microphone) of the reference acoustic signal emitted by a sample acoustic warning device of known type and preferably having optimal performance.

For example, a conventional acoustic warning device comprising a fixed-coil motor, a metal diaphragm and an outlet formed by a trumpet may be used to generate the reference acoustic signal.

According to a preferred embodiment of the invention, the digital samples stored may not be produced as a result of the action of an acoustoelectric transducer but by suitable analysis of the characteristics of the reference acoustic signal and its synthesis with the use of appropriate mathematical models.

Preferably, before the digital samples representative of the reference acoustic signal are stored in the microcontroller μP, they are processed suitably in order to perform an equalization which takes account at least of the frequency response of the loudspeaker LDSK. In particular, a pre-emphasis of the components which are penalized by the stages which follow the microcontroller μP and by the loudspeaker LDSK is performed.

This solution which envisages the synthesis and the processing of the samples on the basis of mathematical models is particularly advantageous because it allows for the complete control of the parameters which contribute to the definition of the tone of the sound. Moreover, by suitable processing based on the mathematical model, it is possible to modify the sound characteristics to obtain sounds different from that of the original allowing, therefore, a personalisation of the sound emitted by the device 100.

In particular, the plurality of samples stored in the flash memory comprises a sub-plurality of samples corresponding to a portion of the electrical signal representing a stage in which the sound of the reference acoustic signal is maintained, that is, a stage in which the sound has stabilized and has a substantially constant volume.

This maintenance stage is the intermediate stage between an initial or switching-on stage of an acoustic warning device and a final, or switching-off stage thereof

According to a preferred embodiment of the invention, the plurality of samples stored in the memory means also comprises a further sub-plurality of samples which correspond to the switching-on or initial stage of the acoustic warning and, advantageously, comprises another sub-plurality of samples which corresponds to the switching-off or final stage of the acoustic warning.

It is pointed out that the initial stage of the acoustic warning has a predominant effect for the signalling function performed and has a harmonic content notably different from that of the other two stages. In the switching-off stage, a decay in the volume of the acoustic signal emitted takes place predominantly.

For example, the initial and switching-off stages have respective durations of approximately 20 ms, whereas the samples relating to the maintenance stage correspond to a duration of about 30 ms. As will become clearer from the following description, the samples relating to the maintenance stage will be used cyclically.

With reference to the acoustic-warning operative condition of the emitting device 100, the microcontroller μP is arranged to process the plurality of digital samples stored and to generate therefrom a modulated electrical signal S1 to be sent on the first driving line DR-1. This modulated signal S1 carries the harmonic content associated with the samples and hence with the reference acoustic signal.

In particular, the spectrum of the modulated signal S1 will contain components having frequencies correlated with that of the acoustic signal to be emitted.

According to the embodiment described, the microcontroller μP also makes available, on a second driving line DR-2, another modulated electrical signal S2 which is a phase-inverted replica of the modulated signal S1 present on the first driving line DR-1.

Preferably, the microcontroller μP performs a PWM modulation on the basis of the samples stored, that is, the modulated signal S1 is a PWM (pulse-width modulated) pulsed signal.

This PWM modulated signal S1 is a signal with two states formed by a train of pulses the width (that is, the duration) of which varies in dependence on the curve of the reference acoustic signal, for example, the pulse duration is correlated with the values of the samples.

The techniques for achieving PWM modulation are known and do not require detailed description. In any case, the signal S1 can be produced by a PWM modulator including, for example, a suitable voltage comparator for comparing a PCM (pulse code modulated) signal corresponding to the above-mentioned digital samples stored in the appropriate memory of the microcontroller μP with a saw-toothed waveform and generating the binary PWM signal. Examples of PWM modulators usable for the present invention are described in the article “TMS320C67-Based Design of a Digital Audio Power Amplifier, Introduction, Novel Feedback Strategy”, by Erik Bresch and Wayne T. Padgett, which is available on the MathWorks Internet site at the following address: http://www.mathworks.com/products/dsp_comm/pdfs/hbreschpadgett.pdf. However, suitable conventional PWM modulators of other types may also be used.

With reference to the capability of the emitting device 100 to operate as an alarm siren, the microcontroller μP is arranged to make available on the first driving line DR-1 a suitable driving signal SQ-1 to be supplied to the driver circuit DRV-CR. In particular, this driving signal is a square wave the frequency of repetition of which is correlated with, in particular equal to, the frequency of the desired acoustic signal.

As stated above, the microcontroller μP can make available on the second line DR-2, another signal SQ-2 corresponding to a phase-inverted replica of the square wave SQ-1 present on the first driving line DRV-1. For the alarm siren operative condition, the signals SQ-1 and SQ-2 emitted by the microcontroller μP preferably also have a frequency modulation, for example, of the sinusoidal type, which is necessary for the reproduction of the “sweep” typical of an alarm siren.

According to one particular embodiment of the invention, the square wave SQ-1 which drives the emission of the acoustic signal characteristic of an alarm siren is not generated by a sampling process, but by frequency division of the timing signal of the microcontroller μP.

It is pointed out that the various above-described functions of the electronic control circuit 50 can be performed by the microcontroller μP by executing a program loaded by means of the inputs IN-1 and IN-2, or some of the functions may be performed by separate dedicated electronic circuits.

Moreover, the acoustic-signal emitting device 100 may also propagate acoustic signals of types other than an alarm siren or an acoustic warning such as, for example, music or voice signals. For this purpose, the electronic control circuit 50 also advantageously has an audio amplifier AUD-AMPL for receiving an analog electrical signal in the audio range (music or voice) at an input terminal IN-AN, for amplifying it suitably, and for supplying it to the microcontroller μP. For example, the audio amplifier AUD-AMPL is of known type and comprises two amplification stages formed by operational amplifiers (not shown) connected in cascade and ensuring the desired gain and suitable input and output impedance values. To permit this further function, the microcontroller μP comprises sampling means suitable for sampling the audio signal received in real time and for generating corresponding signals for driving the loudspeaker LDSK, which are made available on the driving lines DR-1 and DR-2.

Preferably, the analog signal which can be supplied to the input terminal IN-AN of the audio amplifier is a signal coming from a radio receiver, from a stereophonic system, or from a microphone with which the vehicle may be provided.

Moreover, the electronic circuit 50 is optionally provided with a power amplifier stage POW-AMPL, which can be controlled by the microcontroller μP by means of a control line L-C which enables the direct-current battery voltage Vbatt supplied by the battery to be raised to a value HV (for example, of about 30V) and supplied to the driver circuit DRV-CR at levels adequate for driving the loudspeaker LDSK. For example, the power amplifier stage POW-AMPL may comprise a conventional DC/DC (direct current/direct current) converter of the switching type, with the use of an inductance and, as a switch element, a MOSFET transistor.

According to a particular embodiment of the invention, the control circuit 50 comprises a switching circuit SW (controllable by the microcontroller μP) which permits connection of a buffer battery BT-BK with a terminal Vp of its own at which a third voltage Vp can be made available for supply to the stabilized energy supply REG to supply the control circuit 50 with the second voltage Vcc when the motor-vehicle battery is not usable.

According to a preferred embodiment of the invention, the microcontroller μP enables the parameters of the PWM modulated signals S1 and S2 to be modified so as to modify the volume of the acoustic warning signal to be emitted by the loudspeaker LDSK. The modification of the parameters of the modulated signals can be performed on the basis of a volume-control signal supplied, for example, on the input bus L2 and coming from an electronic control unit of the vehicle. A signal of this type could bring about, for example, a reduction in the volume of the acoustic warning signal to within the standard limits permitted at night.

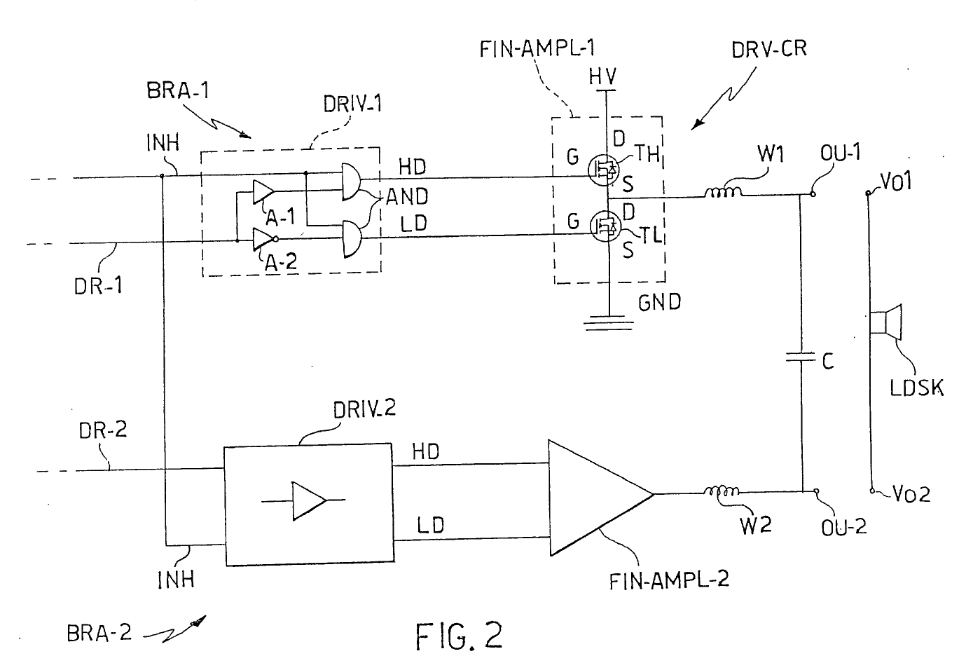

A preferred embodiment of the driver circuit DRV-CR which enables the loudspeaker LDSK to be driven on the basis of the signals emitted by the microcontroller μP on the first driving line DR-1 and on the second driving line DR-2 will now be described with reference to FIG. 2.

Advantageously, the driver circuit DRV-CR is arranged to operate in class D. The amplification techniques used in class D can be considered known and a detailed description thereof is not necessary. The article by Erik Bresch and Wayne T. Padgett mentioned above provides examples of class D audio amplification techniques which are also usable for the present invention. In particular, the article describes (FIGS. 0.1 and 0.2) the use of a PWM demodulator which takes the form of a low-pass filter LC for the reconstruction of an analog signal to be supplied to the loudspeaker, performed on the basis of the PWM signal output by an audio amplifier.

FIG. 2 shows schematically a preferred embodiment of the driver circuit DRV-CR. According to this embodiment, the driver circuit DRV-CR has a bridge configuration (a bridge amplifier) including a first amplification branch BRA-1 and a second amplification branch BRA-2, which are structurally similar to one another, and are intended to supply the loudspeaker LDSK in differential manner by means of a first output terminal OU-1 and a second output terminal OU-2. In particular, the driver circuit DRV-CR is arranged to provide electrical signals in antiphase at the two output terminals OU-1 and OU-2. The loudspeaker LDSK is thus floating, that is, neither of its terminals V01 and V02 has a voltage permanently linked to the earth or to the positive voltage.

The first (second) amplification branch BRA-1 (BRA-2) includes a first (second) driver amplifier DRIV-1 (DRIV-2) and a first (second) final amplifier FIN-AMPL-1 (FIN-AMPL-2).

The first (second) driver DRIV-1 (DRIV-2) has its input connected to the first (second) driving line DR-1 (DR-2) and to a deactivation line INH for an inhibition/activation signal.

Each of the drivers DRIV-1, DRIV-2 is arranged to provide, on an upper output line HD and on a lower output line LD, two suitably amplified copies of the signal present at the input of the driver, in antiphase with one another.

FIG. 2 shows, by means of logic blocks, a preferred architectural layout of the first driver DRIV-1, which is also usable for the second driver DRIV-2. According to this embodiment, the first driver DRIV-1 includes a non-inverting amplifier A-1 and an inverting amplifier A-2, which have respective inputs connected to the first driving line DR-1 and respective outputs connected to corresponding respective AND gates. An output of each AND gate is connected to the upper output line HD or to the lower output line LD. The two AND gates of the first driver DRIV-1 enable the input signal to be combined with the inhibition signal INH in a manner such that, when the latter is activated (for example, when it adopts a low logic level), the operation of the first final amplifier FIN-AMPL-1 is deactivated. Similarly, if the logic value of the inhibition signal INT is switched, the operation of the final amplifiers FIN-AMPL-1, FIN-AMPL-2 is activated.

FIG. 2 also shows schematically a preferred embodiment of the first final amplifier FIN-AMPL-1 (which also applies to the second final amplifier FIN-AMPL-2). According to this embodiment, the first final amplifier FIN-AMPL-1 is a single-ended push-pull amplifier comprising an upper transistor TH and a lower transistor TL each advantageously formed by a MOSFET (metal-oxide semiconductor field effect transistor). In FIG. 2, resistors or capacitors usable for the biasing, decoupling or stabilization of the MOSFET transistors, are not shown, for clarity, since they are obvious to a person skilled in the art.

In particular, the upper transistor TH and the lower transistor TL are n-channel transistors and have gate terminals G connected to the upper output line HD and to the lower output line LD, respectively. Moreover, a source terminal S of the upper transistor TH is connected to a drain terminal D of the lower transistor TL, and hence to the first output terminal OU-1.

A drain terminal D of the upper transistor TH can receive the supply voltage HV generated by the power amplifier stage POW-AMPL, and a source terminal S of the lower transistor LD is connected to the earth GND.

When the first final amplifier FIN-AMPL-1 is in operation, the transistors TH and TL conduct alternately, switching between non-conduction and saturation so that the curve of the electrical signal applied to the upper output line HD of the first driver DRIV-1 is reproduced at the first output terminal OU-1 (apart from a gain factor).

Advantageously, the first driver DRIV-1 is arranged to ensure that the levels of the signals present on the upper and lower output lines HD and LD bring the upper and lower transistors TH and TL to saturation. Moreover, the first driver DRIV-1 preferably enables the first final amplifier FIN-AMPL-1 to be driven, whilst ensuring that the upper and lower transistors are not made conductive simultaneously, giving rise to a dangerous short-circuit between the voltage terminal HV and the earth GND.

This can be achieved by suitable phase displacement of the signals applied to the upper and lower transistors TH and TL and/or by suitable biasing of the transistors. Similar remarks apply to the second driver DRIV-2.

Moreover, it is pointed out that a task of the first driver DRIV-1 is to drive appropriately the upper transistor TH which is formed, according to this embodiment, by an n-type MOSFET. The use of an n-type upper transistor TH, and not a p-type one, as is usual for the circuit configuration shown, renders the driving of the upper transistor by the signal output by the microcontroller μP more advantageous than it would be if a p-type transistor were to be driven.

The two drivers DRIV-1 and DRIV-2 and the two final amplifiers FIN-AMPL-1 and FIN-AMPL-2 may be formed by conventional, commercially-available integrated-circuit devices.

The driver circuit DRV-CR also has filtering means which are interposed between the outputs of the first and second final amplifiers FIN-AMPL-1 and FIN-AMPL-2 and the input terminals of the loudspeaker LDSK and which are formed, for example, by a low-pass filter including a first inductor W1, a second inductor W2, and a capacitor C. The inductors W1 and W2 are disposed between an output terminal of the first final amplifier FIN-AMPL-1 and the first output terminal OU-1 and between an output terminal of the second final amplifier FIN-AMPL-2 and the second output terminal OU-2, respectively. The capacitor C is arranged in parallel with the loudspeaker LDSK.

The filtering means may adopt the function of a demodulator for the reconstruction, from the signals output by the final amplifiers FIN-AMPL-2 and FIN-AMPL-2, of analog driving signals to be supplied to the loudspeaker LDSK.

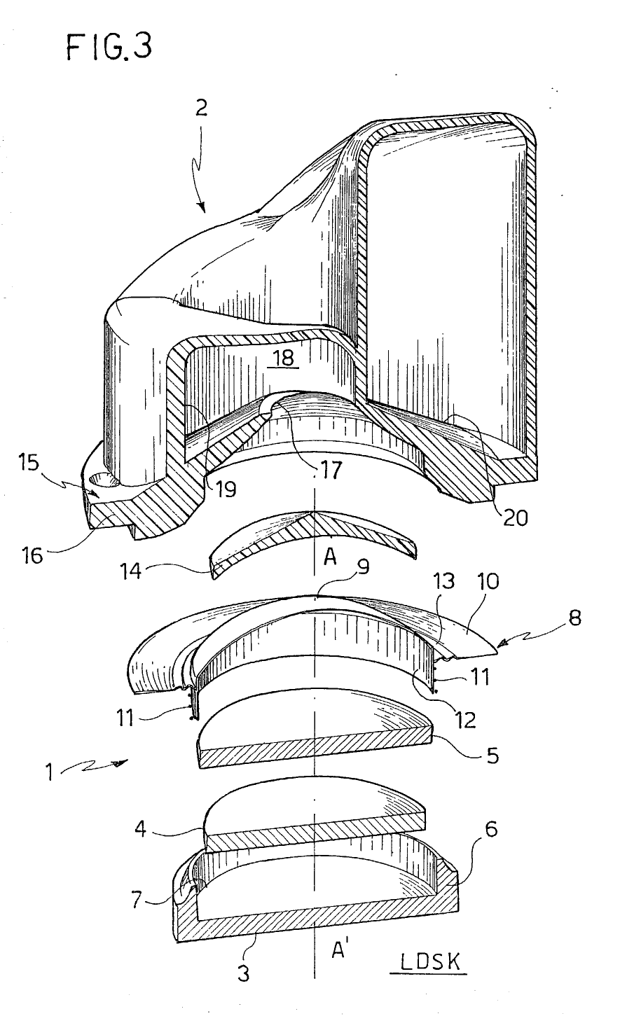

FIG. 3 shows, in an exploded perspective view, a section through a preferred embodiment of the loudspeaker LDSK usable in the present invention. The particular loudspeaker LDSK shown comprises a single electroacoustic transducer device 1, referred to below for brevity as an acoustic driver, and a radiation control structure or diffusing element 2 which can be connected acoustically to the acoustic driver 1.

The acoustic driver 1 has the function of converting the electrical driving signals applied to it into acoustic radiation and is advantageously formed by a moving-coil driver. Moreover, the driver 1 is advantageously of the type with a compression chamber.

The acoustic driver 1 is of a size such that, in addition to the acoustic radiation characteristic of an alarm siren, it can also generate the acoustic radiation characteristic of an acoustic warning device. The size of the acoustic driver 1 can be selected by a person skilled in the art on the basis of the information provided in the present description and of conventional design techniques.

The acoustic radiation which can be generated by the acoustic driver 1 in order to operate as an alarm siren has basic frequencies preferably of between 1500 Hz and 3000 Hz or, more preferably, between 1800 Hz and 2700 Hz. The acoustic radiation which can be generated by the acoustic driver 1 in order to operate as an acoustic warning device preferably has basic frequencies of between 200 Hz and 400 Hz or, more preferably, between 250 Hz and 350 Hz.

It is pointed out that moving-coil acoustic drivers with compression chambers are not used to form acoustic warning devices according to the prior art. Drivers of this type have been used to form loudspeakers for alarm sirens. In fact, acoustic drivers of this type are not generally considered suitable for the emission of acoustic radiation at frequencies within the range which is of interest for acoustic warning devices. Their use for emitting sounds characteristic of an acoustic warning device is therefore innovative and the satisfactory performance which has been found experimentally is surprising.

In greater detail, the acoustic driver 1 comprises a support plate 3 which is made, for example, of metal and is of circular shape, a permanent magnet 4 which is intended to bear on the support plate 3, and a metal closure disc 5 to be placed on top of the magnet 4. The support plate 3 has a collar 6 in the vicinity of its edge so as to define a cavity 7 in which to house the magnet 4.

The acoustic driver 1 also includes a vibrating element preferably formed by a single diaphragm 8 and comprising a substantially spherical cap-shaped vibrating region 9 connected to an annular rim 10. The cap-shaped element 9 is substantially rigid and has a peripheral region which is connected to the annular rim 10 in a manner such that the cap can vibrate relative to the annular rim. In particular, this is achieved by the formation of a suitably corrugated connecting region 13 between the cap 9 and the annular rim 10. The vibrations of the diaphragm 8 take place along a vibration axis A-A′ which coincides with the geometrical axis of the cap 9. The cap 9 has its convex side facing the diffusing element 2. The diaphragm 8 is made, for example, of a cloth suitably treated with bakelite.

The diaphragm 8 is connected mechanically to a coil 11 wound on a circular support wall 12 fixed firmly to the vibrating cap 9. The coil 11 is connected to the electrical input terminals V01 and V02 of the loudspeaker LDSK and is fixed to the diaphragm 8.

The acoustic driver 1 also has a first, substantially dome-shaped element 14 (with its convex side facing the diffusing element) which is intended to be arranged directly above the cap 9 and so as not to overlap the annular rim 10.

In the assembled configuration of the driver 1, the permanent magnet 4 is housed in the cavity 7 and is covered by the closure disc 5. The circular wall 12 which supports the coil 11 is disposed in the space between the permanent magnet 4 and the collar 6 so that the coil and the magnet are sufficiently close together to achieve adequate electromagnetic coupling. The various components described can be held in position by conventional fixing means (not shown).

It is pointed out that the closure disc 5 and the first dome-shaped element 14 define a compression chamber in which the diaphragm 8 can vibrate.

The vibration of the diaphragm 8 is due to the movements of the coil 11 resulting from the interaction of the variable magnetic field, which is generated when the driving signals output by the driver circuit DRV-CR pass through the coil, with the static magnetic field produced by the magnet 4.

During the vibration of the diaphragm 8 and, in particular, of the cap 9, the air contained in the chamber is compressed and, together with the sound waves, can emerge solely at the side of the first dome-shaped element 14, following a suitable S-shaped path until it is conveyed suitably towards the diffusing element 2. The diffusing element 2 has the function of suitably propagating the radiation emitted by the acoustic driver 1 out of the device 100 and, in particular, out of the vehicle.

According to one advantageous embodiment of the invention, the acoustic diffusing element 2 is a trumpet which defines a guide for the acoustic radiation. In fact, it has been found experimentally that, with the use of a trumpet, it is possible to achieve satisfactory efficiency in the radiation of the sound waves with frequencies typical of acoustic warning devices without appreciably penalizing the sound waves with frequencies typical of alarm sirens. It should be noted that the use of a trumpet coupled with an acoustic driver of the type described is innovative and the good performance achieved and demonstrated experimentally was not initially predictable.

The trumpet 2 may be of the straight type but is preferably a twisted trumpet so as to define a radiation path which winds about an axis.

It should be noted that the twisted configuration of the trumpet 2 is particularly advantageous since it reduces the overall size of the emitting device 100.

The trumpet 2 comprises a second, substantially dome-shaped element 15 having its concave side facing towards the diaphragm 8 and having, in its central portion, an opening 17 through which it can receive the sound waves generated by the acoustic driver 1. This second dome-shaped element 15 has an acoustic coupling function and is intended to be disposed above the first dome-shaped element 14 of the acoustic driver 1 so as to clamp the annular rim 10 of the diaphragm 8 by means of its own outer rim 16.

The trumpet 2 comprises a guide which defines a curved path, for example, a spiral path 18 having a hole 19 communicating with the opening 17 at one end and a radiating mouth 20 at the opposite end. The guide 18 is tapered, that is, the hole 19 has smaller dimensions than the mouth 20.

Preferably, the control circuit 50 can be arranged in the vicinity of the loudspeaker LDSK. The loudspeaker LDSK can be fitted in the vehicle in conventional manner and, advantageously, with the use of a moving-coil acoustic driver such as that described by way of example above; it is not necessary to use specific support brackets because, for this type of driver, the fixing to the vehicle is less critical for its operation.

The operation of the emitting device 100 according to the invention will now be described.

It is assumed that the user of the vehicle in which the emitting device 100 is fitted generates the horn-activation signal H-S, by pressing the pushbutton. The signal H-S, which is supplied to the first control line L1, reaches the microcontroller μP. After the microcontroller μP has recognized the horn-activation signal H-S, it generates modulated signals S1 and S2 (in antiphase) and sends them, via the driving lines DR-1 and DR-2, to the driver circuit DRV-CR the operation of which is activated by bringing the inhibition signal INH to the appropriate logic level.

In greater detail, the microcontroller μP reads the contents of the storage means, processes the sub-plurality of samples stored which relate to the initial stage of the acoustic warning, PWM modulates a train of pulses (on the basis of these samples) and sends the driving signals S1 and S2 thus obtained to the driver circuit DRV-CR.

The modulated signals S1 and S2 corresponding to the sound maintenance stage are then sent to the driver circuit DRV-CR. In particular, the microcontroller μP cyclically repeats the modulation of the train of pulses with the digital samples corresponding to the maintenance stage and sends the modulated signals to the driver circuit DRV-CR until the horn-activation signal H-S is deactivated.

When the horn-activation signal H-S is deactivated, the microcontroller μP, operating in a similar manner to that described above, generates and sends to the driver circuit DRV-CR the driving signals S1 and S2 corresponding to the switching-off stage of the acoustic warning.

In any one of the initial, maintenance and switching-off stages, the first and second drivers DRIV-1 and DRIV-2 of the driver circuit DRV-CR bring the modulated signals S1 and S2 which are present as inputs to suitable levels and generate in appropriate manner driving signals (again of PWM type) which are made available on the upper and lower driving lines HD and LD.

The final push-pull amplifiers FIN-AMPL-1 and FIN-AMPL-2, operating between non-conduction and saturation, amplify the input signals in appropriate manner and supply them to the loudspeaker LDSK.

It is pointed out that the use of PWM driving signals is particularly advantageous since it causes the upper and lower transistors TH and TL of the final amplifiers FIN-AMPL-1 and FIN-AMPL-2 to operate at saturation levels (alternately and throughout the duration of each pulse). In comparison with the operation of the transistors in regions of linearity, this reduces the power dissipated in the transistors in the form of heat and increases output, at the same time rendering the heat dissipation of the device 100 less problematic.

The bridge driver circuit DRV-CR sends the amplified driving signals in antiphase to its own output terminals OU-1 and OU-2. These signals are then applied to the terminals V01 and V02 of the coil 11 which, by virtue of the interaction with the static magnetic field of the magnet 4, causes the diaphragm 8 to vibrate in a manner correlated with the curve of the voltage applied to the terminals of the coil.

It is pointed out that the use of a driver circuit DRV-CR with a bridge configuration offers a considerable advantage since it achieves a large swing of the voltage applied to the terminals of the coil 11 (in particular, a swing is obtained which is twice that of the voltage present at only one of the output terminals OU-1 and OU-2) and hence a corresponding greater range of movement of the diaphragm 8. In particular, the bridge configuration quadruples the power delivered to the load constituted by the loudspeaker LDSK and thus increases the acoustic power that can be obtained.

The use of PWM modulation has the advantages of transferring a high power to the load and thus achieving a high sound level of the acoustic signals emitted, limiting energy dissipation in the final amplification stages (FIN-AMPL-1 and FIN-AMPL-2). Moreover, these advantages are further increased by virtue of the use of a driver circuit DRV-CR with a bridge configuration.

The vibrations of the diaphragm 8 bring about the emission of sound waves which emerge from the compression chamber and are collected by the second dome-shaped element 17 which transmits them to the sound guide 18 of the trumpet 2. The acoustic radiation travelling along the guide 18 reaches the mouth 19 and is radiated to the exterior. The acoustic radiation radiated by the diffusing element 2 substantially reproduces the acoustic signal which can be generated by the sample conventional acoustic warning device in the various stages of operation.

For completeness of description, some specifics are reported relating to a possible structure of the sample acoustic warning device and to the modes with which the switching-off stage of the sound can be achieved.

As already said, the sample acoustic warning device can be of a conventional type. In particular, such a sample warning device is of the type comprising a pair of acoustic warning devices, each provided with its own acoustic driver (for example, of the fixed-coil type) and a corresponding diffuser (hereinafter for brevity referred to as, “dual horn” warning device). In the functioning of a conventional dual horn warning device the two acoustic warning devices are made, during the maintenance phase, to emit sounds having fundamentally distinct frequencies: one frequency F1 and another frequency F2.

In conventional dual horn acoustic warning devices, the values of the frequencies F1 and F2 are selected so that during the maintenance stage the sounds emitted by the two warning devices are composed giving rise to an appropriate overall sound. In particular, it is useful that the values of these frequencies F1 and F2 are such so as to produce a relative dissonance which reinforces the effect of “warning” characteristic of an acoustic warning device, without this dissonance resulting so acute as to generate an excessively unpleasant sound.

In particular, it is to be remembered that the more these frequencies F1 and F2 are closer to each other, the greater the effect of dissonance. Suitable values for these frequencies are, for example, F1=503,799 Hz and F2=400,076 Hz for a ratio F1/F2 =34/27; or F1=476,074 Hz and F2=399,902 Hz for a ratio F1/F2 =25/21.

With reference to the device 100 of the invention, in the particular case in which it is considered a dual horn type sample acoustic warning device, the sub-plurality of samples relative to the maintenance stage stored within the memory of the microprocessor μP is such as to make it that the overall sound emitted by the device 100 results as an overall composite of the frequency F1, and frequency F2 and of the respective harmonic components.

It is observed that these considerations are also valid in the case in which the subplurality of samples stored in the memory of the microprocessor μP is obtained through synthesis and analysis based on a mathematical model which, therefore, will refer to a dual horn acoustic warning device.

With reference to samples relating to a dual horn warning device, according to the working example of the device 100 which is described above, at the end of the maintenance stage are sent the modulated signals S1 and S2 corresponding to the switching off stage and generated on the basis of the respective subplurality of samples.

It is to be observed that the device 100 whilst passing from the maintenance stage to that of switching off is such that the sounds emitted in the two distinct phases (maintenance-switching off) are correctly matched together so as to avoid distortions.

The way of effecting a correct matching between the two stages (maintenance-switching off) are evidently realisable for a skilled expert, on the basis of this description.

The correct matching of the switching off stage to that of the maintenance is carried out, substantially, in an instant in which the sound component emitted by the device 100 having a frequency F1 is in phase with that of frequency F2.

In the device 100, this coupling between the maintenance stage and that of switching off can be obtained by not activating the switching off stage immediately following the release of the switch (disactivation of the electrical signal activation-warning device H-S), but waiting for a certain interval of time. In particular, this waiting time interval is such so as to make it that the two acoustic waves corresponding to the frequency F1 and F2 are in phase.

It is reasonable to believe that the return to phase of the two sound components with frequencies F1 and F2 occurs following a time interval correlated with the periods of the two frequencies F1 and F2. For example, such a time interval is equal to the lowest common multiple of the periods of the two frequencies F1 and F2. This operating mode can be administered by the appropriately programmed microprocessor μP.

It is observed that using this solution which necessitates a waiting period, cases can occur in which the beginning of the switching off stage with respect to the moment of the release of the switch can be excessively late.

To obviate such inconvenience, according to another embodiment of the invention one can envisage not using the subplurality of samples relating to the specific switching off stage.

According to this other embodiment of the invention, the reproduction of the switching off stage is effected using the same subplurality of samples relating to the maintenance phase but creating an appropriate fall in volume, i.e. of the sound level, of the acoustic signal emitted so as to reach the complete switching off of the latter. The reduction in volume can be effected thanks to a related modality foreseen in the program loaded into the microcontroller μP.

In greater detail, following the deactivation of the activation-warning device H-S electrical signal, the microprocessor μP, starting from the same samples representative of the maintenance phase, could generate the PWM type modulated signals S1 and S2. These modulated signals S1 and S2, having the form of a train of pulses of duration correlating with the samples to which they refer will exhibit a reduced average duration with respect to the average duration shown during the maintenance stage. Furthermore, the average duration of these pulses is more and more reduced over time until the complete extinction of the sound.

It is observed that the duration of the PWM pulses is significant regarding the energetic content associated with these signals and therefore is relevant in fixing the magnitude of the vibrations of the membrane 8 and, consequently, the sound level of the acoustic signal emitted by the device 100.

Reducing over time the average duration of these pulses one obtains the lowering of the volume of the acoustic signal emitted reproducing in a satisfactory manner a switching off stage.

This further embodiment of the switching off stage allows one to avoid those problems related with the machining between the maintenance phase and the switching off phase which we have mentioned above and does not require waiting for a certain intermediate time prior to the activation of the switching off phase. Moreover, this alternative embodiment makes use of the samples relating to the maintenance stage without the necessity to store samples relating to the specific switching off stage and therefore avoids a mathematical analysis of the harmonic content of this last stage.

In order to operate the emitting device 100 as an alarm siren, the siren-activation signal SR-S is supplied to the input stage INP-STG which amplifies it and sends it to the microcontroller μP. The microcontroller μP makes the square wave signals SQ-1 and SQ-2 in antiphase available on the first and second driving lines DR-1 and DR-2 on the basis of the siren-activation signal SR-S.

The driver circuit DRV-CR suitably amplifies these square-wave signals so as to drive the loudspeaker LDSK with an ON/OFF-type control. Sound waves with frequencies and acoustic qualities typical of those of an alarm siren are thus emitted. It is pointed out that the same driver circuit DRV-CR which is used for the amplification of the PWM modulated signals S1 an S2 is advantageously also used for the amplification of the square-wave signals SQ-1 and SQ-2.

With regard to the capability to emit music or voice acoustic signals, when the microcontroller μP receives the audio-range signal which arrives from the audio amplifier AUD-AMPL, it samples the signal and generates corresponding driving signals. Preferably, the driving signals are PWM signals and are supplied to the driver circuit DRV-CR which controls the loudspeaker LDSK, operating in a similar manner to that described for the emission of the acoustic warning signal.

With reference to the capability offered by the device 100 to emit signals indicating status, when the microcontroller μP receives the respective control signals (by means of the bus L2 and the input stage INP-STG), it generates corresponding driving signals to be sent to the driver circuit DRV-CR. The driving signals relating to the emission of status-indicating signals may be generated by the microcontroller μP by local synthesis in the same manner as for the alarm siren signal, or may be generated with the use of digital samples obtained in a manner similar to that described for the acoustic warning signal. Moreover, the driving signals emitted by the microcontroller μP for the emission of the indicating signals may be, for example, of the square-wave type, or of the PWM type.

The control circuit 50 and the emitting device 100 according to the invention have many advantages.

With reference to the acoustic-warning function, it should be noted that the control circuit 50 is particularly advantageous in terms of performance. In fact, it has been noted that the use of digital samples obtained by processing outside the control circuit 50 and the generation of a corresponding modulated signal S1 (S2) for driving the loudspeaker LDSK has enabled the harmonic content of the signal characteristic of an acoustic warning device to be reproduced particularly satisfactorily without rendering the electronic control circuitry complex. It is pointed out that the advantages achieved are noticeable in particular when the digital samples stored have been obtained by the action of an acoustoelectric transducer and also when these samples have been obtained by suitable synthesis of the signal characteristic of an acoustic warning signal performed outside the device 100.

It has also been observed that, given the complexity and the particular nature of the harmonic content (and hence of the sound) of the signal characteristic of an acoustic warning device, its reproduction by conventional synthesis techniques performed locally by the same circuitry which is associated with the electroacoustic transducer leads to unsatisfactory results as well as considerably complicating the electronic circuitry.

In particular, it has been noted that local synthesis of the acoustic warning signal achieved by multiplication, mixing and division operations starting with a reference frequency leads to the emission of a signal which sounds quite different from that emitted by a conventional horn.

It should also be noted that the use of a moving-coil acoustic driver with a compression chamber coupled with a trumpet-type diffusing element has enabled particularly satisfactory performance to be achieved for the various functional capabilities of the device 100.

The acoustic-signal emitting device 100 according to the invention offers the advantage of combining the functional capabilities of an alarm siren with those of an acoustic warning device in a single device so that the space occupied and the cost to the user are reduced in comparison with those of two separate devices for the two-functions.

A further advantage of the device 100 is that it enables signals indicating vehicle state also to be emitted with the use of the same electronic circuit 50 and the same loudspeaker LDSK which are used for the alarm siren and acoustic warning functions.

Moreover, as described with reference to the audio amplifier AUD-AMPL of FIG. 1, the device 100 according to the invention has further characteristics of versatility since it can also operate as an audio system or a megaphone and can propagate, outside the vehicle, music or voice signals corresponding to electrical signals generated by a radio, by an audio system, or by a microphone fitted in the vehicle.

Naturally, in order to satisfy contingent and specific requirements, a person skilled in the art may apply to the control circuit and to the signal-emitting device according to the present invention further modifications and variations all of which, however, are included within the scope of protection of the invention as defined by the appended claims.

1. An electronic control circuit (50) of a loudspeaker (LDSK) for vehicles for emitting at least a first acoustic signal characteristic of an alarm siren, said electronic circuit comprising:
a storage means for storing a plurality of digital samples representative of at least one portion of a reference acoustic signal which may be generated by a sample acoustic warning device,
a processing means for generating, on the basis of the plurality of samples, a modulated electrical signal (S1, S2) carrying at least a portion of the harmonic content associated with the reference acoustic signal, and
a driver circuit (DRV-CR) for receiving the modulated electrical signal (S1; S2) and supplying to the loudspeaker (LDSK) a corresponding driving signal for the emission of a second acoustic signal substantially reproducing the at least one portion of the reference acoustic signal.

2. A circuit (50) according to claim 1 in which the modulated signal (S1; S2) is a PWM (pulse-width modulated) pulsed signal.

3. A circuit (50) according to claim 2 in which the driver circuit (DRV-CR) comprises at least one amplification stage (FIN-AMPL-1) for amplifying the PWM modulated electrical signal, including at least a first transistor (TH) and a second transistor (TL) which are intended to operate in saturation.

4. A circuit (50) according to claim 1 in which the loudspeaker (LDSK) has a first input terminal (V01) and a second input terminal (V02) and the driver circuit (DRV-CR) has a bridge configuration in order to supply to the first and second terminals respective driving signals in antiphase and correlated with said modulated signal (S1; S2).

5. A circuit (50) according to claim 3 in which the first transistor (TH) and the second transistor (TL) are n-channel MOSFETs.

6. A circuit (50) according to claim 1, provided with at least one control line (L1; L2) connected to the processing means for receiving a horn-activation signal (H-S) for the emission of the second acoustic signal and a siren-activation signal (SR-S) for the emission of the first acoustic signal.

7. A circuit (50) according to claim 6, in which the plurality of samples stored comprises a sub-plurality of samples representing a portion of the reference acoustic signal corresponding to a stage of maintenance of the sound of the sample acoustic warning device, and in which the processing means are arranged to send the modulated signal (S1; S2) cyclically to the driver circuit (DRV-CR) during a period of time in which the horn-activation signal (H-S) is activated.

8. A circuit (50) according to claim 7 in which the plurality of samples includes a first sub-plurality of samples representing a first portion of the reference acoustic signal corresponding to a switching-on stage of the sample acoustic warning device.

9. A circuit (50) according to claim 8 in which the plurality of samples includes a second sub-plurality of samples representing a second portion of the reference acoustic signal corresponding to a switching-off stage of the sample acoustic warning device.

10. A circuit (50) according to claim 1 in which the driver circuit (DRV-CR) further comprises filtering means for filtering the driving signal to be supplied to the loudspeaker.

11. A circuit (50) according to claim 6 in which the processing means are also arranged to generate at least one first driving signal (SQ-1; SQ-2) to be sent to the driver circuit (DRV-CR) for the emission of the first acoustic signal by the loudspeaker (LDSK).

12. A circuit (50) according to claim 11 in which the at least one first driving signal (SQ-1; SQ-2) is a square-wave and may be generated by the processing means by frequency division of a timing signal (CK).

13. A circuit (50) according to claim 1 in which the processing means enable parameters of the modulated electrical signal (S1; S2) to be modified so as to modify the volume of the second acoustic signal emitted by the loudspeaker (LDSK) on the basis of a volume-control signal supplied to the processing means.

14. A circuit (50) according to claim 6 in which the at least one control line (L1, L2) receives a signal for controlling the emission by the loudspeaker (LDSK) of at least one signal indicating vehicle state, the processing means permitting the generation, from the control signal, of a second driving signal to be sent to the driver circuit (DRV-CR).

15. A circuit (50) according to claim 1, further comprising an input terminal (IN-AN) for receiving at least one audio electrical signal and in which the processing means are arranged to sample the audio electrical signal and to generate a third PWM driving signal to be sent to the driver circuit (DRV-CR).

16. A circuit (50) according to claim 1 in which the loudspeaker (LDSK) is dimensioned to generate acoustic radiation with frequencies characteristic of an alarm siren and acoustic radiation with frequencies characteristic of an acoustic warning device.

17. A circuit (50) according to claim 1 in which the plurality of digital samples are produced by processing, performed outside the control circuit (50), of an electrical signal resulting from an acoustoelectric conversion on the reference acoustic signal.

18. A circuit (50) according to claim 1 in which the plurality of digital samples is obtained by synthesis of the reference acoustic signal performed outside the device (100).

19. A circuit (50) according to claim 1 in which the loudspeaker (LDSK) comprises a transducer (1) for receiving signals output by the driver circuit (DRV-CR) and converting them into acoustic radiation.

20. An acoustic-signal emitting device (100) for vehicles, the device comprising a loudspeaker (LDSK) for emitting at least a first acoustic signal characteristic of an alarm siren and an electronic control circuit (50) for sending driving signals to the loudspeaker (LDSK), the device being characterized in that the electronic control circuit (50) of claim 1 is formed so as to enable the loudspeaker (LDSK) to emit a second acoustic signal characteristic of an acoustic warning device.

21. A device (100) according to claim 20 in which the loudspeaker (LDSK) comprises:
a transducer device (1) connected electrically to the driver circuit (DRV-CR) in order to receive the driving signals and to convert them into acoustic radiation, the transducer device (1) being dimensioned to generate acoustic radiation having frequencies characteristic of an alarm siren in a first operative condition and acoustic radiation having frequencies of an acoustic warning device in a second operative condition,
a diffusing element (2) for the acoustic radiation, coupled with the transducer device in order to propagate the acoustic radiation emitted by the transducer device (1) outside the emitting device (100).

22. A device (100) according to claim 21 in which the transducer device (1) is of the moving-coil type.

23. A device (100) according to claim 22 in which the transducer device (1) includes a compression chamber.

24. A device (100) according to claim 23 in which the diffusing element is a trumpet (2).

25. A device (100) according to claim 24 in which the transducer device (1) comprises a diaphragm (8) which is intended to vibrate along a vibration axis (A-A′) within a compression chamber in dependence on the driving signals, the trumpet (2) defining a guide (18) for the acoustic radiation.

26. A device (100) according to claim 25 in which the trumpet (2) is a twisted trumpet (2) and has a first opening (19) for receiving the radiation generated by the transducer device (1) and a radiating mouth (20) having larger dimensions than the first opening.

27. A device (100) according to claim 25 in which the transducer device (1) comprises:
a permanent magnet (4) for generating a static magnetic field,
a coil (11) which is mechanically connected to the diaphragm (8) and through which the driving signals are intended to flow, generating an electromagnetic field which interacts with the static magnetic field to bring about vibrations of the diaphragm (8), and
a first closure element (5) and a second closure element (14) for defining a compression chamber including the diaphragm (8).

28. A device (100) according to claim 21 in which the loudspeaker (LDSK) is suitable for generating acoustic signals with basic frequencies between 1500 Hz and 3000 Hz in the first operative condition and acoustic signals with basic frequencies between 200 Hz and 400 Hz in the second condition.

29. Circuit (50) according to claim 8, further comprising a switching off stage of the sample acoustic warning device wherein the means for processing (μP) is operative to generate the modulated electronic signal starting from said first subplurality of samples, the modulated electronic signal being such that the acoustic signal emitted presents a decrease in the sound level.

30. A circuit (50) according to claim 9, wherein the modulated electronic signal that is sent to the loudspeaker (LDSK) is a train of pulses having decreasing duration over time so as to reduce to silence the sound level of the acoustic signal emitted.
